(19) United States
(12) Patent Application Publication
(10) Pub. No.: US 2013/0107110 A1
(43) Pub. Date: May 2, 2013

(54) CAMERA MODULE

(71) Applicant: Samsung Electro-Mechanics Co., Ltd., Gyeonggi-do (KR)

(72) Inventors: Chang Sung Park, Gyeonggi-do (KR); Seung Hwan Kim, Gyeonggi-do (KR); Suk Jin Ham, Seoul (KR)

(73) Assignee: SAMSUNG ELECTRO-MECHANICS CO., LTD., Gyeonggi-do (KR)

(21) Appl. No.: 13/664,350

(22) Filed: Oct. 30, 2012

(30) Foreign Application Priority Data
Oct. 31, 2011 (KR) 10-2011-0112392

(51) Int. Cl. H04N 5/225

(52) U.S. Cl. 348/373; 348/E05.024

(57) ABSTRACT

Disclosed herein is a camera module, including: a camera sensor; a case having the camera sensor accommodated therein; a transparent member mounted to penetrate through an inside and an outside of the case; and a humidity removing unit removing humidity of the transparent member. By this configuration, it is possible to automatically remove humidity formed on the transparent member (external window or external lens) contacting external air and automatically remove foreign materials such as dust attached on the surface of the transparent member. Therefore, even though the camera module according to the exemplary embodiments of the present invention is used in the outdoor environment, it is possible to obtain the clear image at all times.

### CROSS REFERENCE(S) TO RELATED APPLICATIONS

This application claims the benefit under 35 U.S.C. Section 119 of Korean Patent Application Serial No. 10-2011-0112392, entitled “Camera Module” filed on Oct. 31, 2011, which is hereby incorporated by reference in its entirety into this application.

### BACKGROUND OF THE INVENTION

1. Technical Field

The present invention relates to a camera module, and more particularly, to a camera module used as a rear view camera for a vehicle to be able to obtain a clear image regardless of external environment.

2. Description of the Related Art

A camera module has been currently used in various fields. In particular, describing a rear view camera mounted in a vehicle as one example, a new vehicle in which a rear view camera as a parking assistant apparatus is basically mounted has been often released, but a rear view camera has been often sold separately at an aftermarket.

Recently, a rear view camera is going to be mounted in all vehicles to be released in the United States by 2014 due to the passage of a rear camera mounting obligation bill in North America. For the reason of easiness or safety of parking, a consumer's demand for a rear view camera for a vehicle has been explosively increased all over the world.

However, the rear view camera for a vehicle is mounted at the outside of a vehicle and is thus greatly affected due to external environment such as weather, and the like. For example, an external window or an external lens portion of the rear view camera may get damp due to, for example, a sudden change of temperature. The external window or the external lens portion is polluted due to dust, exhaust, and the like, of a road and, as a result, a driver's view may be blocked.

In this case, there is a disadvantage in that a driver or passengers get off a vehicle to remove humidity or pollutants of the rear view camera. In addition, even though the humidity of the external window or the external lens is removed under the environment that humidity is generated, humidity may be generated again. Therefore, the method for removing humidity manually has a limitation. The external window or the external lens may be continuously polluted according to a driving of a vehicle.

The foregoing problems may be common to general cameras used in the environment that the external window or the external lens of a closed circuit television, and the like, in addition to the rear view camera for a vehicle may be polluted.

### SUMMARY OF THE INVENTION

An object of the present invention is to provide a camera module capable of automatically removing humidity or pollutants formed on a lens unit or an external window contacting external air.

According to an exemplary embodiment of the present invention, there is provided a camera module, including: a camera sensor; a case having the camera sensor accommodated therein; a transparent member mounted to penetrate through an inside and an outside of the case; and a humidity removing unit removing humidity of the transparent member.

The humidity removing unit may be a heating wire.

The heating wire may be formed of silver (Ag) paste.

The humidity removing unit may be piezoelectrics.

The camera module may further include a humidity sensor sensing the humidity of the transparent member.

The transparent member may be a lens.

The humidity removing unit may be formed to enclose a side portion of the transparent member.

### BRIEF DESCRIPTION OF THE DRAWINGS

FIG. 1 is a perspective view of a camera module according to an exemplary embodiment of the present invention.

FIG. 2 is a front view of the camera module shown in FIG. 1.

FIG. 3 is a partial cross-sectional view taken along the line I-I′ shown in FIG. 1.

### DESCRIPTION OF THE PREFERRED EMBODIMENTS

Hereinafter, exemplary embodiments of the present invention will be described in detail with reference to the accompanying drawings. However, this is only by way of example and therefore, the present invention is not limited thereto.

When technical configurations known in the related art are considered to make the contents obscure in the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

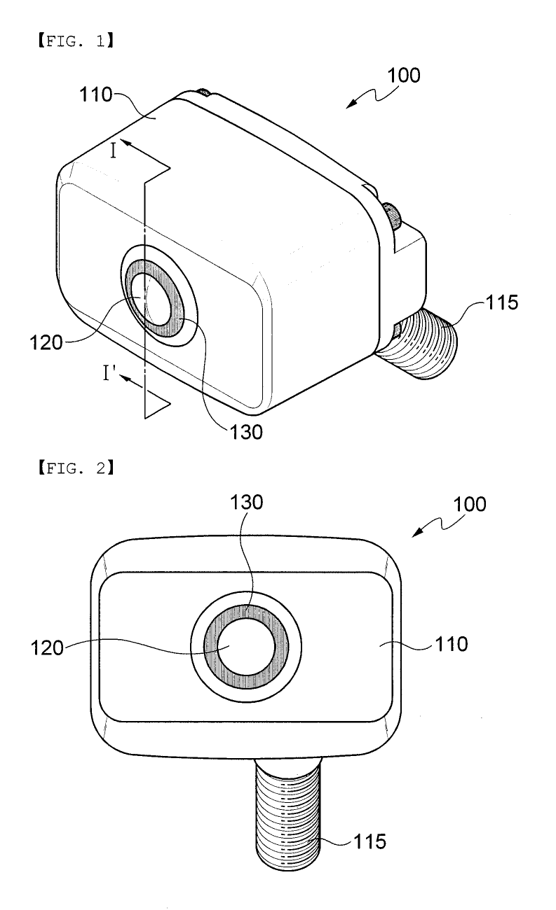

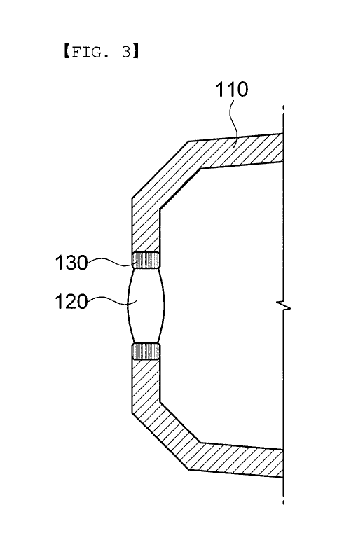

FIG. 1 is a perspective view of a camera module according to an exemplary embodiment of the present invention, FIG. 2 is a front view of the camera module shown in FIG. 1, and FIG. 3 is a partial cross-sectional view taken along the line I-I′ shown in FIG. 1.

Referring to FIGS. 1 to 3, a camera module 100 according to an exemplary embodiment of the present invention may include a camera sensor (not shown), a case 110, a transparent member 120, and a humidity removing unit 130.

The camera sensor (not shown) is one of the most important components acquiring an image. As the camera sensor, an image sensor such as a charge coupled device (CCD), a complementary metal oxide semiconductor (CMOS), and the like, that are generally used, may be used.

In addition, the case 110 has the camera sensor accommodated therein and a signal line transferring a signal of the camera sensor is extracted to the outside. In addition, the case 110 may be completely sealed so as to prevent foreign materials, and the like, from being infiltrated into the case 110 and as a result, humidity is not generated into the sealed case 110.

Further, one portion of the case 110 is provided with a screw type fixing part 115 and as a result, the case 110 may be easily fixed to objects to be fixed by a screwed fitting type. In particular, when the camera module 100 is applied to a rear view camera of a vehicle, the fixing part 115 is formed at the same standard as a license plate fixing bolt. Therefore, the license plate fixing bolt is removed and then, the camera module 100 according to the exemplary embodiment of the present invention is screw-fitted at a position at which the fixing bolt is removed, such that the case 110 may be easily mounted.

Meanwhile, the transparent member 120 is mounted to penetrate through an inside and an outside of the case 110. That is, the camera sensor photographs external images of the case 110 through the transparent member 120.

However, the transparent member 120 is in contact with external air and therefore, humidity is essentially generated due to a temperature difference. In the case of freezing weather, humidity is frozen and therefore, it is more difficult to remove humidity. As described above, when humidity is generated on the transparent member 120, it is impossible for the camera sensor to acquire an image. In particular, when the camera module is used for the rear view camera mounted in a vehicle, a safety accident may occur.

The camera module 100 according to the exemplary embodiment of the present invention may include the humidity removing unit 130 for removing the humidity of the transparent member 120 to obtain the clear image at all times, regardless of external environment.

As the humidity removing unit 130, a heating wire may be used. The humidity of the transparent member 120 is evaporated by heat generated from the heating wire and therefore, the camera module 110 according to the exemplary embodiment of the present invention can acquire the clear image at all times.

In addition, when the heating wire is operated at all times, electricity may be unnecessarily wasted and therefore, the operation of the heating wire can be controlled if necessary. In particular, when the camera module is used for the rear view camera for a vehicle, the heating wire cooperates with a gearbox and thus, may be operated only when the gearbox is on the reverse.

In addition, the heating wire is formed of silver (Ag) paste and may be manufactured by a printing process.

Meanwhile, as the humidity removing unit 130, piezoelectrics may also be used. The piezoelectrics mean materials that derive polarization in a material when external mechanical pressure is applied thereto and that are mechanically deformed by external electric field.

When power is applied to the piezoelectrics, vibration occurs together with heat, which may remove the humidity of the transparent member 120 and pollutants such as dust attached on the surface, and the like, using the characteristics thereof.

When the camera module is used in the outdoor environment, the humidity is generated and the pollutants such as dust, and the like are attached, such that the field of vision of the camera sensor is blocked. The transparent member 120 is vibrated while the humidity of the transparent member 120 is removed using heat generated from the piezoelectrics, thereby removing the pollutants of the surface.

In addition, the camera module 100 according to the exemplary embodiment of the present invention may further include a humidity sensor that senses the humidity of the transparent member 120. When the humidity is generated through the humidity sensor, the humidity removing unit 130 is automatically operated to prevent electricity from being unnecessarily wasted and obtain the clear image at all times.

As the humidity sensor, a sensor sensing diffused reflection due to humidity like a lane sensor of a vehicle may be used. In addition, a method of analyzing an image acquired by the camera sensor and sensing that humidity is generated when blur or distortion occurs in the image may be used, instead of the separate humidity sensor.

In addition, the humidity removing unit 130 may be formed to enclose a side portion of the transparent member 120. This is to efficiently transfer heat/vibration generated from the humidity removing unit 130 to the transparent member 120 while securing an optimal field of vision by preventing the humidity removing unit 130 from blocking the field of vision of the camera sensor.

Meanwhile, the transparent member 120 may be a lens. The transparent member 120 serves as a lens controlling an angle of view and a focus while serving as a transparent window for photographing the outside of the case 110, such that the number of components and costs of the camera module 100 according to the exemplary embodiment of the present invention can be saved, thereby improving productivity.

For reference, although the exemplary embodiment of the present invention describes, for example, the case in which the camera module is used for the rear view camera for a vehicle, it is not limited thereto. Therefore, the exemplary embodiment of the present invention can be applied to all the camera modules used in the environment in which the humidity or the pollutants may be generated.

According to the camera module of the exemplary embodiments of the present invention, it is possible to automatically remove the humidity formed on the transparent member (external window or external lens) contacting the external air and automatically remove foreign materials such as dust attached on the surface of the transparent member.

Therefore, even though the camera module according to the exemplary embodiments of the present invention is used in the outdoor environment, it is possible to obtain the clear image at all times.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A camera module, comprising:
a camera sensor;
a case having the camera sensor accommodated therein;
a transparent member mounted to penetrate through an inside and an outside of the case; and
a humidity removing unit removing humidity of the transparent member.

2. The camera module according to claim 1, wherein the humidity removing unit is a heating wire.

3. The camera module according to claim 2, wherein the heating wire is formed of silver (Ag) paste.

4. The camera module according to claim 1, wherein the humidity removing unit is piezoelectrics.

5. The camera module according to claim 1, further comprising a humidity sensor sensing the humidity of the transparent member.

6. The camera module according to claim 1, wherein the transparent member is a lens.

7. The camera module according to claim 1, wherein the humidity removing unit is formed to enclose a side portion of the transparent member.
